(19) United States
(12) Patent Application Publication
(10) Pub. No.: US 2012/0059748 A1
(43) Pub. Date: Mar. 8, 2012

(54) System and method for adaptive billing

(75) Inventors: Kotaro Matsuo, Poway, CA (US); Christopher Hall, Rancho Santa Margarita, CA (US)

(73) Assignee: SMITH MICRO SOFTWARE, INC., ALISO VIEJO, CA (US)

(21) Appl. No.: 12/807,404

(22) Filed: Sep. 3, 2010

(51) Int. Cl. G06Q 30/00

(52) U.S. Cl. 705/34

(57) ABSTRACT

Provided are systems and methods for execution by a processor of a client device and/or a provisioning system to provide adaptive billing. One method comprises receiving one or more available network access plans from a network provider when a current usage of a client device has passed a usage threshold of a current network access plan, providing the available network access plans for selection by a user, receiving a selected network access plan from the user, and transmitting the selected network access plan to the network provider to increase usage of the client device according to the selected network access plan.

### BACKGROUND OF THE INVENTION

1. Field of the Invention

The present invention relates generally to telecommunications. More particularly, the present invention relates to adaptive billing for telecommunications and data access.

2. Background Art

A current trend in wireless telecommunication and data services is to migrate away from unlimited calling, messaging and data plans and replace them with limited usage and/or pre-pay usage plans. One incentive for network providers to do so may be market pressure from consumers who wish to pay only for their own granular usage and not to subsidize the usage of other consumers that may be able to better exploit the open-endedness of an unlimited usage plan.

However, limited usage and pre-pay usage plans typically require accurate usage reporting and provisioning, which requires various costly upgrades to the wireless infrastructure across the market. At the same time, limited usage plans include the potential for overage fees associated with exceeding a usage cap. As has been reported widely in the press, overage fees have had a large negative effect on consumer views of the wireless services industry, particularly with respect to “bill shock” caused by the delay between overage usage and overage billing. This has lead to a substantial increase in customer churn in the traditionally stable long-term contract market, which has significantly reduced revenue predictability for many wireless services providers. In addition, many providers have had to increase spending on customer support to inform users of specific terms of limited usage plans, and a substantial number of such providers have also had to increase spending on customer billing services in order to negotiate and settle large overage fees.

Ironically, while wireless services providers have spent a substantial amount of resources on infrastructure supporting the limited usage and pre-pay services requested by consumers, providers continue to experience problems with customer dissatisfaction stemming from the shift in billing practices.

Accordingly, there is a need to overcome the drawbacks and deficiencies in the art by providing a billing methodology that both protects the user and provides revenue predictability for the wireless carrier.

### SUMMARY OF THE INVENTION

There are provided systems and methods for adaptive billing, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for providing adaptive billing according to one embodiment of the present invention;

FIG. 2 presents a diagram of a system for providing adaptive billing according to one embodiment of the present invention;

FIG. 3 shows a flowchart describing the steps, according to one embodiment of the present invention, by which adaptive billing may be provided.

FIG. 4 shows a flowchart describing the steps, according to one embodiment of the present invention, by which adaptive billing may be provided.

### DETAILED DESCRIPTION OF THE INVENTION

The present application is directed to a system and method for adaptive billing. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

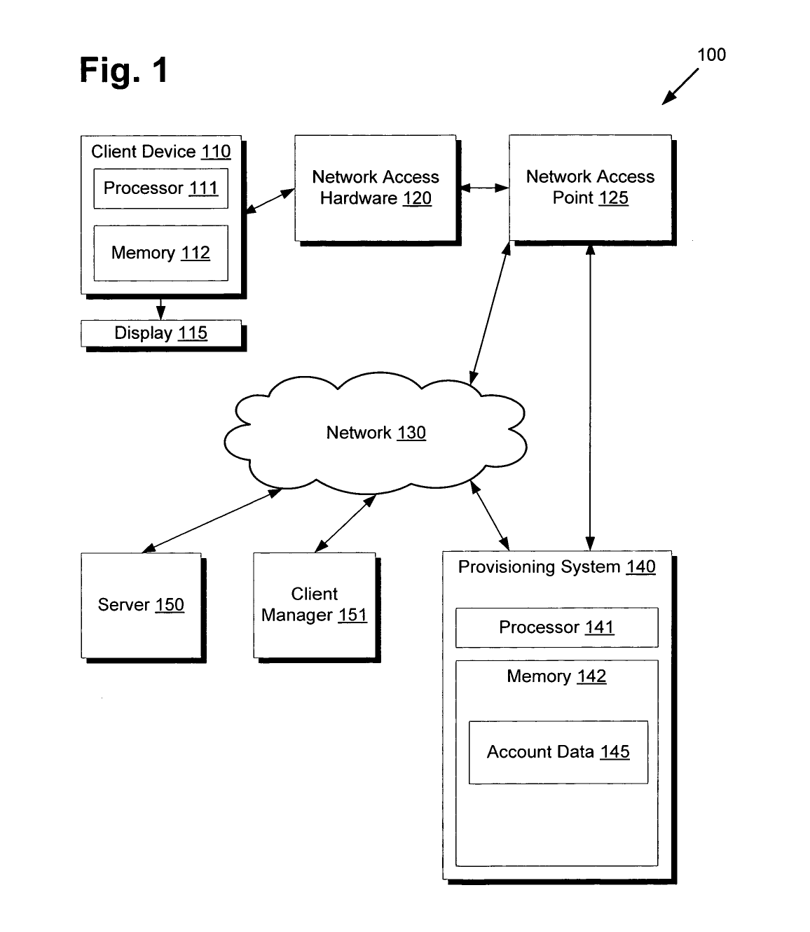

FIG. 1 presents a diagram of a system for providing adaptive billing, according to one embodiment of the present invention. System 100 of FIG. 1 includes client device 110, display 115, network access hardware 120, network access point 125, network 130, provisioning system 140, server 150 and client manager 151. Client device 110 includes device processor 111 and device memory 112. Provisioning system 140 includes system processor 141 and system memory 142. System memory 142 includes account data 145.

Client device 110 may comprise, for example, a desktop computer, a laptop computer, a tablet computer, a videogame console, a mobile phone, or any device capable of accessing network 130, accepting user input and outputting to display 115. Display 115 may, for example, comprise an integrated or external LCD display. Network 130 may, for example, comprise a public network such as the Internet or a cellular network.

To provide the user of client device 110 with network access, some method of connecting to network 130 is required. Network access hardware 120 may, for example, comprise a mobile broadband or WWAN data card, a DSL modem, a cable modem, a WLAN data card, a cellular terminal, or another device connectable to network access point 125. Network access hardware 120 may, for example, comprise an integrated or external network access device. Network access point 125 may comprise, for example, a cellular tower for a network provider or additional servers or equipment necessary for a network provider. Network access point 125 may be configured to access a wide area network (WAN), such as a cellular network or the Internet, for example, or a local area network (LAN), for example. Network access point 125 may also be configured to be compliant with a particular wireless technology standard used in wireless networking or telephony, such as WiMAX (e.g., Institute of Electrical and Electronics Engineers (IEEE) 802.16-complaint) or WiFi (e.g., IEEE 802.11-compliant), for example.

Thus, client device 110 can connect to network 130 using the provided network access hardware 120. However, client device 110 is not provided unrestricted access to network 130. All network access requests from client device 110 are first routed to provisioning system 140 by, for example, a network provider in control of provisioning system 140 and, for example, servers operating at network access point 125. Then, access to network 130 may be negotiated between client device 110 and provisioning system 140.

Provisioning system 140 may be executing a tracking and provisioning program on processor 141 to allow, disallow, or limit access of client device 110 to network 130, for example. The provisioning program may refer to account data 145 to implement restrictions regarding access to network 130 or a subset of network 130. Network usage of client device 110 may be tracked and stored within account data 145 and be submitted instantaneously or periodically for monitoring or billing. Substantially concurrently, client device 110 may be executing a tracking, reporting and selection program on processor 111 to locally track and store network usage, provide account data 145 received from provisioning system 140, and to provide network access options, e.g. network access pricing options or network access plans, to a user for continued network access. While only a single provisioning system 140 and a single client device 110 is shown in FIG. 1, alternative embodiments may use multiple provisioning systems for load balancing and to support a large number of clients devices.

To provide an example, server 150 might comprise a web server for a search provider, or, alternatively, server 150 might comprise another client device connected to network 130, for example. When client device 110 requests access to server 150, provisioning system 140 may consult account data 145 to determine if there are any restrictions on client device 110 accessing either network 130 or server 150. One such restriction would be if current usage of client device 110 has reached or surpassed a usage threshold of a current network access plan with regard to its usage of network 130, as set under a pre-pay usage plan, for example, or under a limited usage plan. Another such restriction could be where client device 110 is only allowed to use network 130 to access specific phone numbers or specific servers, for example, using a “walled-garden” approach to limit access to a subset of network 130. If there are no restrictions, then provisioning system 140 may allow access and continue to monitor the access for usage beyond a usage threshold, for example. If there are restrictions, or if current usage reaches or is nearing a usage threshold, provisioning system 140 may transmit account data 145 to client device 110 to provide notification of an access restriction, for example, and to provide one or more available network access plans for continued usage.

When client device 110 receives account data 145 from provisioning system 140, client device 110 may report account data 145 using display 115, for example. If current usage has reached or surpassed a usage threshold, for example, or if some other restriction on network access is enabled, client device 110 may also provide a selection of available network access plans for accessing network 130. Such network access plans may reside in account data 145 and may be defined by a network provider, for example, or may be defined through negotiation between a user and a network provider. Once a network access plan is selected, client device 110 may transmit the selected network access plan to provisioning system 140, which may use the selected plan together with account data 145 to dynamically provision access of client device 110 to network 130 and thereby increase an overall usage of client device 110.

By providing a system that can dynamically provision network access through direct user interaction, the present invention provides a system for adaptive billing of access to a network that protects a user by providing notification to the user and by providing a selection of available network access plans to the user for continued use. Moreover, by allowing a user to control their usage and billing adaptively, there is less potential for bill shock and other unintended consequences of limited usage billing, thus potentially reducing customer dissatisfaction and customer churn. As a result, the present invention may provide an increase in the predictability of revenue for network providers, which may lead to reduced operating costs for providers and reduced fees for users.

Also shown in FIG. 1 is client manager 151. Client manager 151 might comprise a client device much like client device 110, for example, and although shown connected directly to network 130, client manager 151 may alternatively be connected to network 130 through network access hardware and a network access point, such as those used with client device 110. Furthermore, although client manager 151 is shown in conjunction with a single client device 110 and a single provisioning system 140, it should be understood that client manager 151 may also be configured to connect to multiple client devices and provisioning systems across one or more networks.

Client manager 151 may be used to monitor and manage client device 110 by receiving account data 145 from provisioning system 140, for example, providing account data 145 to a manager, and then transmitting a selected network access plan chosen by the manager to provisioning system 140. Alternatively, client manager 151 may receive a user-selected network access plan from client device 110 or provisioning system 140, for example, provide the user-selected plan along with account data 145 to a manager, and then accept or override the user-selected plan by transmitting a network access plan selected by the manager (e.g., a manager's option) to provisioning system 140. Such a system may be used, for example, when a business wishes to directly monitor and manage network usage of its employees, or when a parent wishes to manage the network usage of a child.

For example, client device 110 may be in the possession of a child, and client manager 151 may be in the possession of a parent. If client device 110 reaches or surpasses a usage threshold, provisioning system 140 may transmit account data 145 to both client device 110 and client manager 151, for example, to notify both the child and the parent. The child, acting as a non-authoritative user of client device 110, may only be allowed to temporarily de-provision network access of client device 110, or may not be allowed to select any network access plans, for example. If the child is allowed to select at least one network access plan, client device 110 may transmit the child's selected plan to client manager 151 directly, or may transmit the selected plan to provisioning system 140, which may then forward the selected option to client manager 151.

The parent, acting as an authoritative user of client device 110, may use client manager 151 to receive account data 145 and, if available, the child's selected plan, and then use any combination of account data 145 and the child's selected plan, for example, to select a manager's option that is transmitted to provisioning system 140. Then, using the manager's option as the authoritative selected plan for network access, provisioning system 140 may use the parent's selected plan together with account data 145 to dynamically provision access of client device 110 to network 130 and thereby increase usage of client device 110, as described herein. As can be seen, a system including client manager 151 increases user control of billing and usage, and thus potentially reduces customer churn and other negative consequences of conventional limited use billing.

Although much of the preceding has discussed adaptive billing in the context of ongoing limited usage plans, it may also apply to pre-pay usage plans. For example, a pre-pay usage plan user without the ability to purchase additional access through client device 110 may find themselves without access in a time of need, or may be required to ration themselves inconveniently. A likely result from either option is an unsatisfactory customer experience. Providing adaptive billing control to pre-pay users may encourage less restrictive use while providing a means to purchase additional access immediately when desired. This potentially increases revenue from pre-pay usage plans and may also engender increased brand loyalty.

In addition to the functionality of client device 110 described above, client device 110 may also be configured to store a local copy of account data 145 in device memory 112 in order to reduce interaction with provisioning system 140 and to report usage data even when not connected to provisioning system 140. Under such circumstances, client device 110 may track its own network usage and update its local copy of account data 145 using local usage data until such time as is convenient to synchronize its local copy with account data 145 on provisioning system 140. Moreover, client device 110 may also use its updated local copy of account data 145 to provide a selection of network access options in preparation for connection with provisioning system 140.

Providing account data 145, and the available network access plans that may be contained within, to a user may take many forms. In addition to methods particularly suited for display 115 (e.g., visual notifications such as graphical icons, text messages or emails), client device 110 may be configured to provide account data 145 using sounds, such as those generated by a voice synthesizer, for example. Client device 110 may be additionally configured to obtain a network access plan selected by a user through use of voice response or recognition, for example. Moreover, client device 110 may be configured to provide account data 145 by transmitting account data 145, including an updated local copy, to client manager 151 as discussed above. Regardless of the method used, the providing of account data 145 by client device 110 serves to notify a user of a current usage of client device 110 and any access restrictions, thereby providing a means for timely adaptive billing, as explained herein.

As noted above, a selection of available network access plans may be unilaterally determined by a network provider or may be negotiated between a user and a provider, for example, when entering into a services contract. In particular, a user may be allowed to limit the number and type of available network access plans in order to simplify a process of choosing a plan using client device 110. Once a set of available network access plans is determined, those network access plans and their status (e.g., whether they are displayed or whether they are enabled) may be included in account data 145 to facilitate user tracking and reporting, both to the user directly and to the provider's billing services, in order to assist in reconciliation support.

In the context of a limited usage plan, such as a long term contract with month-to-month billing, for example, available network access plans may include, without limitation, temporarily de-provisioning the client device when a maximum usage limit is reached, exceeding the maximum usage limit under the terms of the current plan, or upgrading the current plan to a higher usage plan. A restriction for a limited usage plan may be based on a certain period of time or a volume of use, for example, or may be based on a quality of connection, a geographical location, or any other access restriction. In particular, a restriction for a limited usage plan may include a segregation of network access such that only certain phone numbers or Internet addresses, for example, can be accessed. Such restrictions can be used to construct a large selection of available network access plans to facilitate a particular user's needs or to match marketing desires of a network provider.

For example, where a user chooses to temporarily de-provision client device 110 for general network access, the network provider may allow client device 110 to continue to access network 130 to communicate with a home phone number or server 150, for example, or to continue to access provisioning system 140. By allowing continued access to provisioning system 140 even when a user has chosen to temporarily de-provision client device 110, a provider may use provisioning system 140 to provide available network access plans to client device 110 in conjunction with, for example, notification of incoming calls, emails, or other requests for connection to client device 110. Alternatively, where a user chooses to upgrade their limited usage plan to a higher usage plan having a higher maximum usage limit, for example, a provider may provide plan prices designed both to encourage a user to upgrade and to recoup a portion of the revenue lost relative to if the user had instead chosen to exceed a limit under the terms of the previous plan and incur overage charges. Depending on the network access options made available by a provider, a user's upgraded limited access plan may automatically revert to the users original plan at the end of a current billing period.

For instance, in an embodiment of the present invention, a user may enter into a conventional long term contract with a network provider comprising a limited usage plan, where the initial available plans are plan A for $30/month, B for $40/month and C for $50/month. Plans A through C might be the price for network access to the Internet (e.g., network 130) per month, but with varying limits on instantaneous and monthly bandwidth, for example, such that plan A offers 256 kbps maximum instantaneous and 1 GB maximum monthly bandwidths, plan B offers 512 kbps with 2 GB, and plan C offers 1 Mbps with 5 GB. Also, the network provider may include with each plan a set of available network access options or plans that detail overage and upgrade options and their prices and/or specify a selection of addresses that can be reached even if the user surpasses a monthly maximum usage limit, for example. As noted above, each option or plan may include negotiated terms, such as each option's price or whether to include a particular option or plan at all.

If a user chooses plan A and their usage nears their monthly bandwidth limit before the end of the month, for example, the network provider can configure provisioning system 140 to transmit account data 145 to the user's client device 110 automatically so that client device 110 can report access data 145 to the user as well as provide a selection of network access options to the user. For example, client device 110 may report that the user has used 950 MB of their allotted 1 GB of usage and provide the options of de-provisioning client device 110 upon reaching 1 GB of usage for no additional cost, allowing the user to go over their monthly usage bandwidth limit for $4/100 MB of added monthly bandwidth according to the overage charges of plan A, or upgrading to either plan B at $45 or C at $55 prorated for the remainder of the month. Thus, the user is notified of overage consequences while at the same time offered a variety of network access plans allowing the user to continue to access the network. By dynamically adjusting the user's plan, the network provider may maintain a customer satisfaction level that would be lost if the user had exceeded plan A and incurred overage charges.

Even if the user above chooses to temporarily de-provision client device once the 1 GB limit is met, for example, the network provider may still configure provisioning system 140 to push account data 145 to client device 110 and offer available network access plans whenever an incoming connection, such as an incoming email, is detected, for example. Thus, through use of an embodiment of the present invention, the user is additionally protected from lack of network access because the network provider is able to continue the customer relationship even after client device 110 is barred from general access to the network. As noted above, additional user protection mechanisms may benefit a network provider by potentially reducing customer churn.

In the context of pre-pay usage plans, many of the same types of network access options may be provided, but instead of offering network access options including upgrading plans or exceeding a current plan, a provider may offer an option of purchasing a set portion of additional usage, such as an additional portion of time or volume, similar to the process used to enter into an initial pre-play plan, as known in the art. Additionally, a pre-pay usage plan may be offered the option to switch to an ongoing limited usage plan (e.g., to switch types of plans). A pre-pay usage plans user may be required to authorize immediate payment from a bank account or credit card, for example, while a limited usage plan user may only need to grant authorization to charge an appropriate amount at an end of a current billing period.

For example, in an embodiment of the present invention, a user may enter into a conventional pre-pay contract with a network provider comprising a pre-pay usage plan, where the initial available plans are Plans D through F with respective set portions of usage and instantaneous bandwidths of 5 GB at 512 kbps for $60, 10 GB at 1 Mbps for $100, and 20 GB at 1 Mbps for $160. As above, each plan may include a set of available network access plans that detail upgrade options and their prices as well as other negotiated terms. Also as above, the network provider can configure provisioning system 140 to transmit account data 145 to the user's client device 110 automatically so that client device 110 can report access data 145 to the user as well as provide a selection of network access plans to the user. For example, client device 110 may report that the user has reached a maximum usage limit and offer the options of temporarily de-provisioning client device 110, purchasing additional usage piecemeal for $4/100 MB at 256 kbps, purchasing a completely new pre-pay plan at current market prices, or selecting an ongoing limited usage plan such as plans A through C discussed above. As above, even if the user decides to temporarily de-provision client device 110, the network provider may still configure provisioning system 140 to offer available network access plans to the user periodically, thereby increasing usage of client device 110 and potentially reducing customer churn.

By providing infrastructure capable of supporting a wide array of network access options and plans, the present invention allows network providers to manage their customer's satisfaction more granularly and with less delay than with conventional billing methodologies. For example, a provider may be able to respond quickly to market pressures by pushing new network access plans out to a large number of client devices substantially concurrently in order to allow users to adjust their billing accordingly. Moreover, a provider may be able to respond more rapidly to the individual needs of a single user. This increased responsiveness may serve to increase customer satisfaction and thereby reduce customer churn. Alternatively, a provider may choose to offer network access options designed primarily to increase revenue predictability, or choose to test various network access options to see which provide more revenue predictability and which provide higher customer satisfaction, for example.

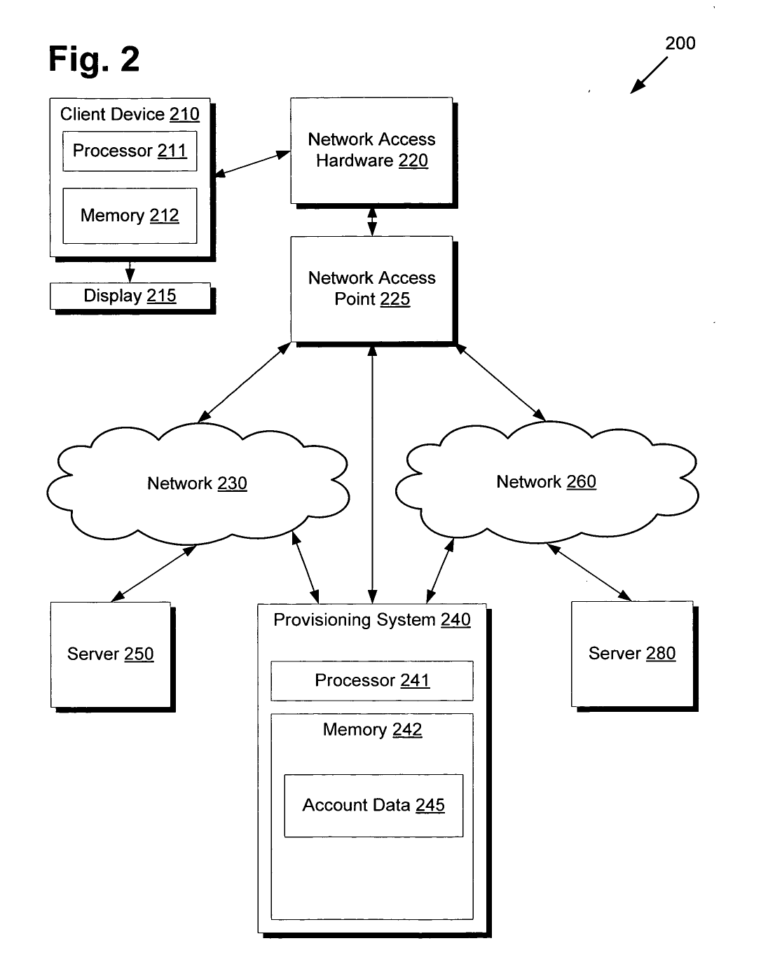

Turning now to FIG. 2, FIG. 2 presents a diagram of a system for providing adaptive billing, according to another embodiment of the present invention. System 200 of FIG. 2 includes client device 210, display 215, network access hardware 220, network access point 225, network 230, provisioning system 240 and server 250 corresponding respectively to client device 110, display 115, network access hardware 120, network access point 125, network 130, provisioning system 140 and server 250 in FIG. 1; e.g., each corresponding structure may be configured to exhibit the same features and/or operate substantially the same as its counterpart. Additionally, system 200 includes network 260 and server 280. Network 260 may, like network 230, comprise a public network such as the Internet or a cellular network. Server 280 might comprise a web server, or, alternatively, server 28.0 might comprise another client device like client device 210 connected to network 260, for example.

Much like provisioning system 140 in FIG. 1, provisioning system 240 may be executing a tracking and provisioning program on processor 241 to allow, disallow, or limit access of client device 210 to network 230, for example. However, provisioning system 240 may additionally be executing the tracking and provisioning program, substantially concurrently, to allow, disallow, or limit access of client device 210 to network 260. Thus, using steps similar to those outlined above with respect to FIG. 1, provisioning system 240 may dynamically provision access of client device 210 to network 230 and network 260 either separately or substantially concurrently. By including that capability, the present embodiment provides a system for adaptive billing with respect to more than one network, substantially concurrently, with all the attendant advantages described above with respect to adaptive billing with respect to only a single network.

For example, where network 230 is the Internet and network 260 is a cellular network, a user may, when provided with available network access plans by client device 210, chose to temporarily de-provision access to the Internet (e.g., network 230) when a maximum usage limit on data usage is met, yet choose to continue access to a cellular network (e.g., network 260) by upgrading the voice portion of the plan to a higher usage plan until, for example, a current billing period has ended. Consequently, an embodiment of the present invention facilitates increased granularity of control and reporting for users while allowing a network provider to extend services into new markets and technologies. For example, although FIG. 2 depicts two networks 230 and 260 accessed through the same network access point 225, client device 210 may access those and additional networks through multiple additional network access points (not shown in FIG. 2) that are connected to multiple provisioning systems through one or more networks and/or network access points.

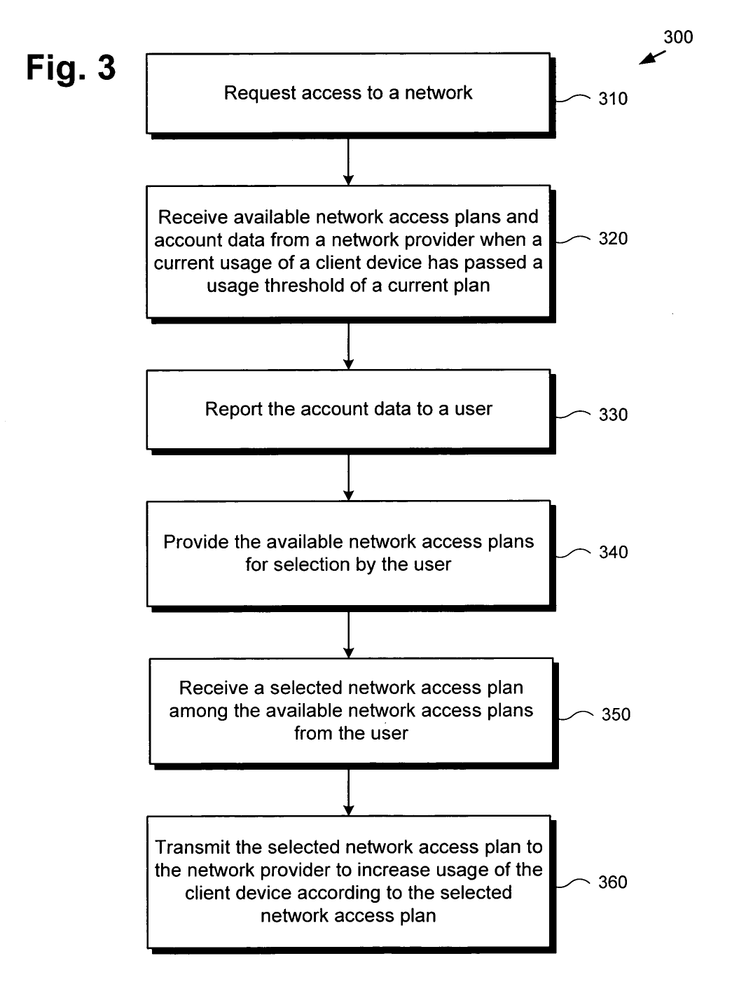

Moving to FIG. 3, FIG. 3 shows a flowchart 300 describing steps, according to one embodiment of the present invention, by which adaptive billing may be provided. Certain details and features have been left out of flowchart 300 that are apparent to a person of ordinary skill in the art. For example, a step may comprise one or more substeps or may involve specialized equipment or materials, as known in the art. While steps 310 through 360 indicated in flowchart 300 are sufficient to describe one embodiment of the present invention, other embodiments of the invention may utilize steps different from those shown in flowchart 300.

Referring to step 310 of flowchart 300 in FIG. 3 and system 100 of FIG. 1, step 310 of flowchart 300 comprises processor 111 of client device 110 transmitting a request for access to network 130. As previously described, client device 110 may use network access hardware 120 to transmit the request to network access point 125, which may forward such requests to provisioning system 140.

Referring to step 320 of flowchart 300 in FIG. 3 and system 100 of FIG. 1, step 320 of flowchart 300 comprises processor 111 of client device 110 receiving available network access plans and account data 145 from provisioning system 140, which is under control of a network provider, when a current usage of client device 110 has passed a usage threshold of a current network access plan. As explained above, provisioning system 140 may transmit account data 145 when client device 110 has reached or surpassed a usage threshold of a current network access plan. In addition, provisioning system 140 may also transmit account data 145 to client manager 151, depending on the type of access control specified in account data 145. Alternatively, client device 110 may expressly request account data 145 in order to synchronize a local copy of account data 145 stored in device memory 112. If client device 110 is well within its usage limit, the network access request may simply be granted and client device 110 will be allowed access to network 130.

In the event that client device 110 has reached or surpassed its usage threshold, provisioning system 140 may, depending on network access options provided within account data 145, foreclose further connection between client device 110 and network access point 125. Alternatively, provisioning system 140 may allow access between client device 110 and a subset of network 130, as well as allow access to provisioning system 140. Also, a usage threshold may be set, by a network provider for example, to be less than a maximum usage limit of a current network access plan, thereby providing ample warning to a user of an impeding access restriction. Regardless of whether access is granted, restricted, or denied, provisioning system 140 may continue to track and store network usage of client device 110.

Referring to step 330 of flowchart 300 in FIG. 3 and system 100 of FIG. 1, step 330 of flowchart 300 comprises processor 111 of client device 110 reporting account data 145 to a user. As previously described, a reporting of account data 145 may serve to notify a user of an approaching usage limit. Client device 110 may report account data 145 using display 115, for example, and may also transmit client data 145 to client manager 151, depending on network connectivity and the type of access control specified in account data 145.

Referring to step 340 of flowchart 300 in FIG. 3 and system 100 of FIG. 1, step 340 of flowchart 300 comprises processor 111 of client device 110 providing one or more available network access plans for selection by the user. Client device 110 may do so, for example, using display 115. As previously described, available network access plans may be defined by a network provider, or through negotiation between the provider and a user, and may be tailored for the type of usage plan currently in use. Available network access plans may additionally be tailored to specific user requests and/or to provide increased revenue predictability for a network provider, for example.

Referring to step 350 of flowchart 300 in FIG. 3 and system 100 of FIG. 1, step 350 of flowchart 300 comprises processor 111 of client device 110 receiving a selected network access plan, selected from among the available network access plans, from the user. As previously described, a user may use client device 110 to select at least one of the available network access plans, by typing in a choice on a keypad, for example, or through voice response. As described above, a selected network access plan may continue, upgrade, or de-provision network access, for example, and may also change the type of usage plan for client device 110, as desired by the user.

Referring to step 360 of flowchart 300 in FIG. 3 and system 100 of FIG. 1, step 360 of flowchart 300 comprises processor 111 of client device 110 transmitting the selected network access plan to provisioning system 140 and, thus, to the network provider, in order to increase usage of the client device according to the terms of the selected network access plan. Client device 110 may transmit a selected plan to client manager 151, or provisioning system 140 may forward a received selected plan to client manager 151, after which client manager 151 may override the selected plan using a manager's option transmitted to provisioning system 140 and incorporated into account data 145.

As described above, by providing a method that can dynamically provision network access through direct user interaction, the present invention provides a method for adaptive billing that protects a user by providing notification to the user and by providing a selection of network access options to the user for continued or increased use. As a result, the present invention may increase customer satisfaction while providing an increase in the predictability of revenue for network providers.

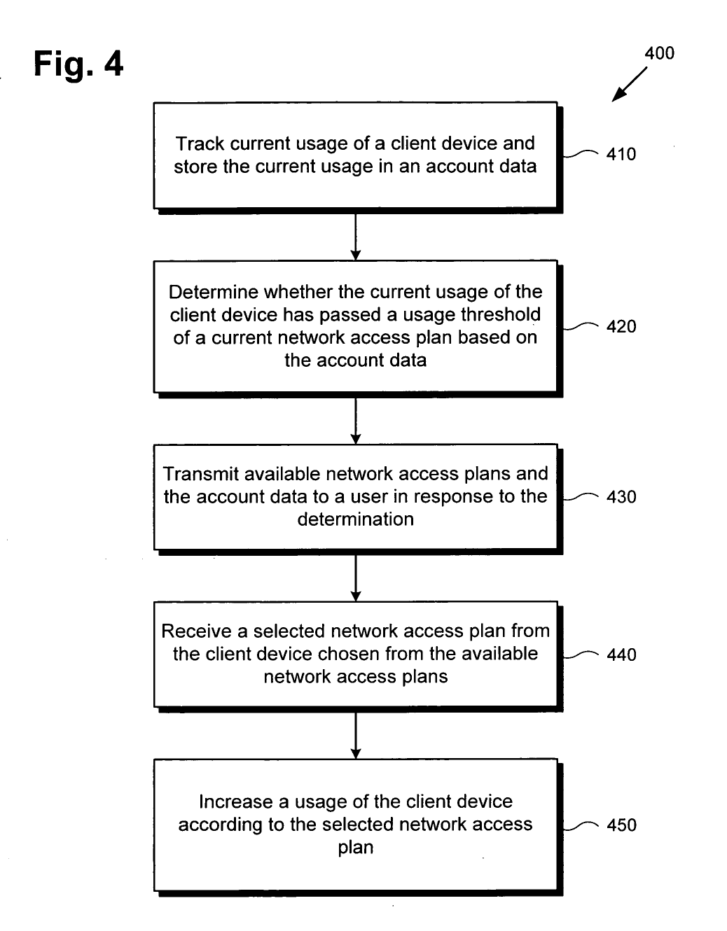

Turning to FIG. 4, FIG. 4 shows a flowchart 400 describing steps, according to one embodiment of the present invention, by which adaptive billing may be provided. Certain details and features have been left out of flowchart 400 that are apparent to a person of ordinary skill in the art. For example, a step may comprise one or more substeps or may involve specialized equipment or materials, as known in the art. While steps 410 through 450 indicated in flowchart 400 are sufficient to describe one embodiment of the present invention, other embodiments of the invention may utilize steps different from those shown in flowchart 400.

Referring to step 410 of flowchart 400 in FIG. 4 and system 100 of FIG. 1, step 410 of flowchart 400 comprises processor 141 of provisioning system 140 tracking current usage of client device 110 and storing a record of the current usage in account data 145. As previously described, provisioning system 140 may continue to do this any time client device 110 is connected to network access point 125.

Referring to step 420 of flowchart 400 in FIG. 4 and system 100 of FIG. 1, step 420 of flowchart 400 comprises processor 141 of provisioning system 140 using account data 145 to determine whether the current usage of the client device has passed a usage threshold of a current network access plan. As previously described, a usage threshold may be set to be less than a maximum usage limit of a current network access plan so as to provide ample warning to a user of an impending access restriction, for example.

Referring to step 430 of flowchart 400 in FIG. 4 and system 100 of FIG. 1, step 430 of flowchart 400 comprises processor 141 of provisioning system 140 transmitting available network access plans and account data 145 to a user. As explained above, provisioning system 140 may transmit either or both when client device 110 has reached or surpassed a usage threshold of a current network access plan. In addition, provisioning system 140 may transmit either or both to client device 110 and/or client manager 151, depending on the type of access control specified in account data 145.

Referring to step 440 of flowchart 400 in FIG. 4 and system 100 of FIG. 1, step 430 of flowchart 400 comprises processor 141 of provisioning system 140 receiving a selected network access plan from the client device chosen from the available network access plans. As previously described, client device 110 or client manager 151 may transmit a selected plan to provisioning system 140 directly, or client device 110 and/or provisioning system 140 may transmit or forward a selected plan to client manager 151, after which client manager 151 may override the selected plan using a manager's option.

Referring to step 450 of flowchart 400 in FIG. 4 and system 100 of FIG. 1, step 450 of flowchart 400 comprises processor 141 of provisioning system 140 increasing a usage of the client device according to the selected network access plan. As described above, processor 141 of provisioning system 140 may use the selected network access plan and account data 145 to dynamically provision access to network 130. For instance, a selected network access plan may continue, upgrade, or temporarily de-provision network access, for example, and may also change the type of usage plan for client device 110. As a specific example, provisioning system 140 may temporarily de-provision client device 140 while allowing access to itself and/or a selection of other servers connected to network 130, for example, to allow a network provider to continue to communicate access data 145 and available network access plans to client device 110. Alternatively, provisioning system 140 may provision access according to the overage terms of a current plan or the terms of a newly selected plan. As a result, usage of client device 110 may continue beyond a maximum usage limit according to the terms of the selected plan, as described in detail above, thereby increasing usage of client device 110.

As described above, by dynamically provisioning network access through direct user interaction, the present invention provides a method for adaptive billing that protects a user by providing notification and a selection of network access options to the user. As a result, the present invention may increase customer satisfaction, thereby increasing usage of client devices generally while providing an increase in the predictability of revenue for network providers.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for execution by a processor of a client device to provide adaptive billing, the method comprising:
receiving one or more available network access plans from a network provider when a current usage of the client device has passed a usage threshold of a current network access plan;
providing the one or more available network access plans for a selection by a user;
receiving a selected network access plan among the one or more available network access plans from the user; and
transmitting the selected network access plan to the network provider to increase a usage of the client device according to the selected network access plan.

2. The method of claim 1, further comprising:
receiving an account data from the network provider; and
reporting the account data to the user.

3. The method of claim 1, further comprising:
tracking the current usage of the client device using a local usage data.

4. The method of claim 1, wherein the selected network access plan comprises limiting access to a subset of a network.

5. The method of claim 1, wherein the selected network access plan comprises upgrading to a higher usage plan.

6. The method of claim 1, wherein the selected network access plan comprises purchasing a set portion of additional usage.

7. The method of claim 1, wherein the selected network access plan comprises switching a first type of usage plan for a second type of usage plan.

8. The method of claim 1, wherein the selected network access plan comprises temporarily de-provisioning the client device.

9. The method of claim 1, further comprising:
transmitting the one or more available network access plans to a client manager.

10. A client device for providing adaptive billing, the client device being configured to connect to a network and comprising:
a processor configured to:
receive one or more available network access plans from a network provider when a current usage of the client device has passed a usage threshold of a current network access plan;
provide the one or more available network access plans for a selection by a user;
receive a selected network access plan among the one or more available network access plans from the user; and
transmit the selected network access plan to the network provider to increase a usage of the client device according to the selected network access plan.

11. The client device of claim 10, wherein the client device is further configured to connect to another network;
the processor being further configured to:
receive another one or more available network access plans;
provide the another one or more available network access plans for another selection by the user;
receive another selected network access plan among the another one or more available network access plans from the user; and
transmit the another selected network access plan to increase the usage of the client device according to the another selected network access plan.

12. The client device of claim 10, wherein the network comprises a wide area network.

13. The client device of claim 10, wherein the network comprises a local area network.

14. A method for execution by a processor of a provisioning system to provide adaptive billing, the method comprising:
tracking a current usage of a client device, wherein the current usage is stored in an account data;
determining that the current usage of the client device has passed a usage threshold of a current network access plan based on the account data;
transmitting one or more available network access plans to the client device in response to the determining; and
receiving a selected network access plan from the client device chosen from the one or more available network access plans;
increasing a usage of the client device according to the selected network access plan.

15. The client device of claim 14, wherein the usage threshold is less than a maximum usage limit of the current network access plan.

16. The method of claim 14, further comprising:
transmitting the one or more available network access plans to a client manager in response to the determining; and
receiving a manager's option from the client manager chosen from the one or more available network access plans, wherein the manager's option overrides the selected network access plan.

17. The method of claim 14, wherein the selected network access plan comprises limiting access to a subset of a network.

18. The method of claim 14, wherein the selected network access plan comprises upgrading to a higher usage plan.

19. The method of claim 14, wherein the selected network access plan comprises switching a first type of usage plan for a second type of usage plan.

20. The method of claim 14, wherein the selected network access plan comprises temporarily de-provisioning the client device.
